(19) United States
(12) Patent Application Publication
(10) Pub. No.: US 2018/0364488 A1
(43) Pub. Date: Dec. 20, 2018

(54) DISPLAY DEVICE

(71) Applicant: SONY CORPORATION, TOKYO (JP)

(72) Inventors: HIDETO MORI, TOKYO (JP); KEN NISHIDA, CHIBA (JP)

(21) Appl. No.: 16/060,216

(22) PCT Filed: Sep. 21, 2016
(86) PCT No.: PCT/JP2016/077778

§ 371 Date: Jun. 7, 2018

(30) Foreign Application Priority Data
Dec. 28, 2015 (JP) 2015-255883

(51) Int. Cl. G02B 27/01; G02B 27/02; G02B 27/22; G02B 7/12; G09G 3/38

(52) U.S. Cl. CPC G02B 27/0172; G02B 27/022; G02B 27/22; G02B 2027/0178; G09G 3/38; G02B 2027/0134; G02B 7/12

(57) ABSTRACT

[Object] To provide a display device capable of widening the stereoscopically visible region.

[Solution] The display device includes: a right eye optical system of a right eye display unit (126R) configured to conduct image light to a right eye; and a left eye optical system of a left eye display unit (126L) configured to conduct the image light to a left eye. A plane passing through the right eye (2R) and a first straight line intersects with a plane passing through the left eye (2L) and a second straight line, the first straight line being perpendicular to a right eye virtual image (30R) formed by the right eye optical system, the second straight line corresponding to the first straight line and being perpendicular to a left eye virtual image (30L) formed by the left eye optical system.

### TECHNICAL FIELD

The present invention relates to a display device.

### BACKGROUND ART

In the related art, technologies of displaying an image with binocular disparity between a left eye and a right eye of a user are proposed. According to such a technology, users are capable of seeing the image stereoscopically, and feeling a sense of depth.

In addition, Patent Literature 1 listed below describes a technology of tilting each of a right eye optical system and a left eye optical system outside to widen an angle of view of observation, the right eye optical system and the left eye optical system being arranged in front of the eyes of a user.

### CITATION LIST

### Patent Literature

Patent Literature 1: JP 2013-25101A

### DISCLOSURE OF INVENTION

### Technical Problem

However, according to the technology described in Patent Literature 1, a region in which an image projected by the right eye optical system and an image projected by the left eye optical system overlap each other becomes small. Therefore, a stereoscopically visible region also becomes small.

Accordingly, the present disclosure proposes a novel and improved display device capable of widening the stereoscopically visible region.

### Solution to Problem

According to the present disclosure, there is provided a display device including: a right eye optical system configured to conduct image light to a right eye and form a right eye virtual image; and a left eye optical system configured to conduct image light to a left eye and form a left eye virtual image. A plane passing through the right eye and a first straight line intersects with a plane passing through the left eye and a second straight line, the first straight line being perpendicular to the right eye virtual image, the second straight line corresponding to the first straight line and being perpendicular to the left eye virtual image.

### Advantageous Effects of Invention

According to the present invention, it is possible to widen a stereoscopically visible region. Note that the effects described here are not necessarily limited, and any effect that is desired to be described in the present disclosure may be exhibited.

### BRIEF DESCRIPTION OF DRAWINGS

FIG. 1 is an explanatory diagram illustrating a configuration example of an information processing system that is common to respective embodiments of the present disclosure.

FIG. 2 is a diagram illustrating a principle of a head-mounted display (HMD) 10-1 according to a first embodiment.

FIG. 3 is a schematic diagram illustrating a field of view and a binocular vision region 32 in accordance with a configuration of the HMD 10-1.

FIG. 4 is a functional block diagram illustrating a configuration example of the HMD 10-1 according to the first embodiment.

FIG. 5 is an explanatory diagram illustrating an example of generating a right eye image and a left eye image on the basis of an image signal of 2D content.

FIG. 6 is an explanatory diagram illustrating a positional relation between a left eye image observed by a left eye and a right eye image observed by a right eye.

FIG. 7 is an explanatory diagram illustrating an example of generating a right eye image and a left eye image on the basis of an image signal of 3D content.

FIG. 8 is an explanatory diagram illustrating an example of a cutout region of a right eye image and a cutout region of a left eye image.

FIG. 9 is graphs illustrating examples of functions of correction to be performed on the respective cutout regions illustrated in FIG. 8.

FIG. 10 is a flowchart illustrating an operation example according to the first embodiment.

FIG. 11 is a diagram illustrating a principle of an HMD 10-2 according to a second embodiment.

FIG. 12 is a functional block diagram illustrating a configuration example of the HMD 10-2 according to the second embodiment.

FIG. 13 is an explanatory diagram illustrating an example of positions of eyes of respective users with respect to a left eye display unit 126L.

FIG. 14 is an explanatory diagram illustrating examples of transfer of a right eye display unit 126R.

FIG. 15 is an explanatory diagram illustrating an example of transfer of the right eye display unit 126R.

FIG. 16 is a flowchart illustrating an operation example according to the second embodiment.

FIG. 17 is an explanatory diagram illustrating a hardware configuration of the HMD 10 that is common to the respective embodiments.

FIG. 18 is an explanatory diagram illustrating a modified example of positional relation between a left eye display and a right eye display according to a modification of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, according to an order of items listed below, the “Mode(s) for Carrying Out the Invention” will be described.
1. Basic configuration of information processing system
2. First embodiment
2. Second embodiment
4. Hardware configuration
5. Modification

Note that, in this specification and the drawings, sometimes the HMD 10-1 according to the first embodiment and the HMD 10-2 according to the second embodiment may be referred to as HMDs 10.

### 1. Basic Configuration of Information Processing System

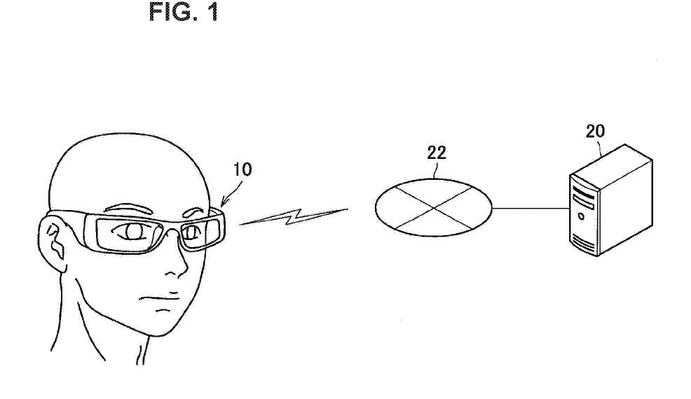

First, with reference to FIG. 1, a basic configuration of an information processing system that is common to respective embodiments of the present disclosure will be described. As illustrated in FIG. 1, the information processing system according to the respective embodiments includes an HMD 10, a server 20, and a communication network 22.

### <1-1. HMD 10>

The HMD 10 is an example of a display device or the information processing device according to the present disclosure. The HMD 10 is a device configured to control display of content and applications. Note that, next, a situation in which the HMD 10 controls display of content will mainly be described. In addition, it is also possible to control display of the applications in a similar way.

For example, the HMD 10 generates a left eye image to be displayed on a left eye display unit 126L (to be described later) and a right eye image to be display on a right eye display unit 126R (to be descried later) on the basis of content received from the server 20 via the communication network 22. Here, for example, the content may be image data recorded in various kinds of recording media, may be image data provided from the server 20 via the communication network 22 or the like, or may be the other media files. In addition, the content may be 2D content or may be 3D content (stereoscopic image).

In addition, basically, the HMD 10 is a see-through head-mounted display as illustrated in FIG. 1. In other words, the right eye display unit 126R and the left eye display unit 126L may include see-through displays. However, the HMD 10 is not limited thereto. The HMD 10 may be a non-see-through head-mounted display.

### <1-2. Server 20>

The server 20 may be a device configured to store a plurality of pieces of content and applications. In addition, in the case where a content acquisition request is received from another device such as the HMD 10 or the like, the server 20 is capable of transmitting content to the other device in response to the received acquisition request.

Note that, in the case where the requested content is not stored in the server 20, the server 20 is capable of transmitting the content acquisition request to another device connected with the communication network 22, and acquiring the content from the other device.

### <1-3. Communication Network 22>

The communication network 22 is a wired or wireless transmission path through which information is transmitted from devices connected with the communication network 22. For example, the communication network 22 may include a public network, various kinds of local area networks (LANs), a wide area network (WAN), and the like. The public network includes the Internet, a satellite communication network, a telephone network, and the like, and the LANs include Ethernet (registered trademark). In addition, the communication network 22 may include a dedicated line network such as an Internet Protocol Virtual Private Network (IP-VPN).

### 2. First Embodiment

### <2-1. Background>

The configuration of the information processing system that is common to the respective embodiments has been described above. Next, a first embodiment will be described. First, a background where the HMD 10-1 according to the first embodiment has been developed will be described.

For example, it is desirable for the HMD 10-1 to cause a user to perceive that virtual display such as a graphical user interface (GUI) is arranged at an appropriate position. Therefore, the virtual display with appropriate sizes and positions should be displayed for a left eye and a right eye in accordance with binocular disparity between the left and right eyes.

However, in publicly-known head-mounted displays, an image displayed by the right eye optical system and an image displayed by the left eye optical system do not overlap each other in a region in which the binocular disparity is more effective than the other cognition (in other words, region close to a user), or the publicly-known head-mounted displays have small overlap regions. Accordingly, the binocular vision region (in other words, region in which a right eye image and a left eye image overlap each other) is hardly formed near the user.

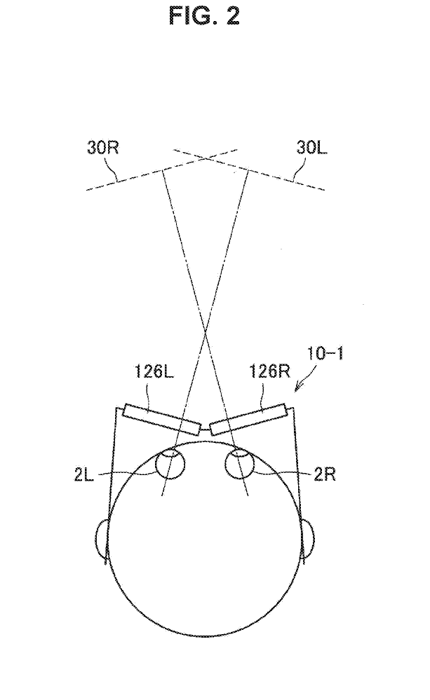

Therefore, the HMD 10-1 according to the first embodiment has been developed in view of the above described circumstance. Next, with reference to FIG. 2, a summary of the first embodiment will be described. FIG. 2 is a diagram illustrating a principle of the HMD 10-1 (top view). The HMD 10-1 includes the right eye optical system configured to conduct image light to a right eye 2R and the left eye optical system configured to conduct image light to a left eye 2L. In addition, the right eye optical system and the left eye optical system are configured such that a plane passing through the right eye 2R and a center line intersects with a plane passing through the left eye 2L and another center line, the center line being perpendicular to a right eye virtual image 30R formed by the right eye optical system, for example, the other center line being perpendicular to a left eye virtual image 30L formed by the left eye optical system, for example.

For example, the right eye optical system may be integrated with a right eye display unit 126R including a light-emitting element, and the left eye optical system may be integrated with a left eye display unit 126L including a light-emitting element. In addition, as illustrated in FIG. 2, the right eye display unit 126R and the left eye display unit 126L may be tilted in a manner that the plane passing through the right eye 2R and the center line intersects with the plane passing through the left eye 2L and the other center line, the center line being perpendicular to the right eye virtual image 30R formed by the right eye optical system, for example, the other center line being perpendicular to the left eye virtual image 30L formed by the left eye optical system, for example.

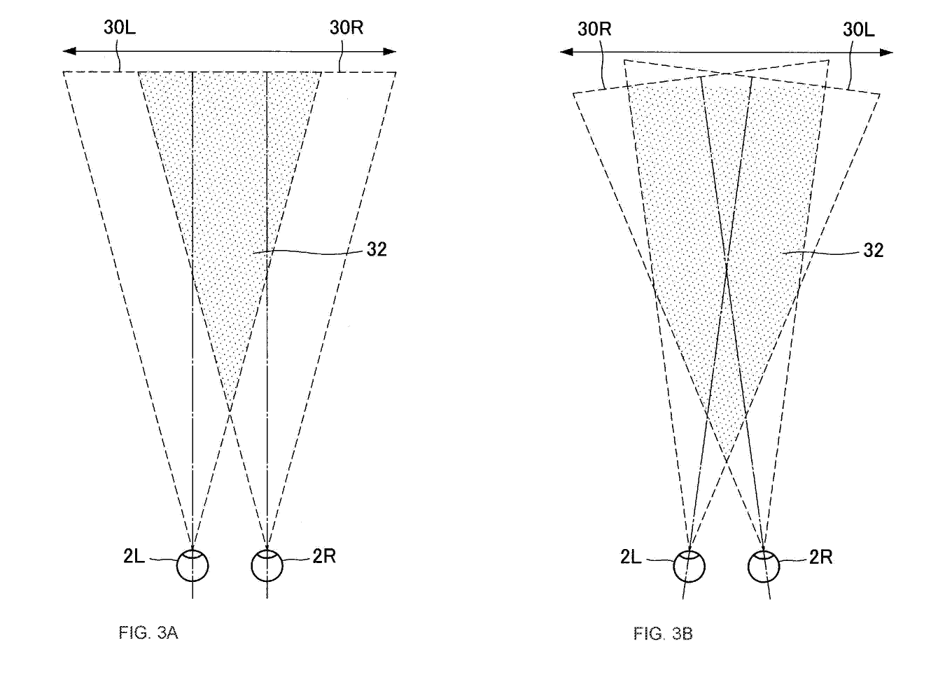

FIG. 3 is a schematic diagram (top view) illustrating a field of view and a binocular vision region 32 in accordance with the above-described configuration of the HMD 10-1. Note that, FIG. 3 (a) is a diagram illustrating a comparative example of the first embodiment, and FIG. 3 (b) is a diagram illustrating the HMD 10-1. Note that, the comparative example illustrates a case where the right eye display unit 126R and the left eye display unit 126L are not tilted (in other words, they are set to be parallel). As illustrated in FIG. 3, the HMD 10-1 forms the binocular vision region 32 staring from a position closer to a user than the comparative example. In addition, as indicated by arrows in FIG. 3, there is almost no difference in sizes of fields of view between the comparative example and the HMD 10-1 at positions away from the user, and the wide field of view is secured.

### <2-2. Configuration>

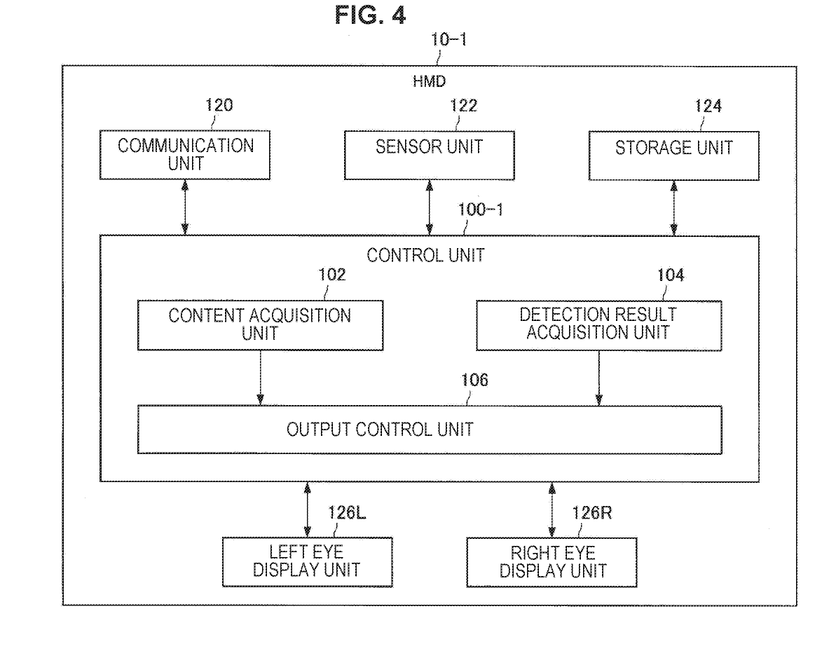

Next, details of the configuration of the HMD 10-1 according to the first embodiment will be described. FIG. 4 is a functional block diagram illustrating the configuration of the HMD 10-1. As illustrated in FIG. 4, the HMD 10-1 includes a control unit 100-1, a communication unit 120, a sensor unit 122, a storage unit 124, the left eye display unit 126L, and the right eye display unit 126R.

### [2-2-1. Control Unit 100-1]

The control unit 100-1 controls entire operation of the HMD 10-1 by using hardware such as a central processing unit (CPU) 150 and random access memory (RAM) 154 (to be described later) that are embedded in the HMD 10-1. In addition, as illustrated in FIG. 4, the control unit 100-1 includes a content acquisition unit 102, a detection result acquisition unit 104, and an output control unit 106.

### [2-2-2. Content Acquisition Unit 102]

The content acquisition unit 102 acquires display subject content. For example, the content acquisition unit 102 receives the display subject content from the server 20. Alternatively, in the case where the content is stored in the storage unit 124, the content acquisition unit 102 is also capable of acquiring the display subject content from the storage unit 124.

In addition, the content acquisition unit 102 is capable of acquiring content information of the content in addition to an image signal of the content. Here, for example, the content information may be meta-information indicating a type, a genre, a title or the like of the content.

### [2-2-3. Detection Result Acquisition Unit 104]

The detection result acquisition unit 104 acquires a result of sensing performed by the sensor unit 122. For example, the detection result acquisition unit 104 acquires detection results such as a speed, acceleration, inclination, positional information, and the like of the HMD 10-1, or a detection result such as brightness of an environment. In addition, the detection result acquisition unit 104 acquires an image captured by the sensor unit 122.

### [2-2-4. Output Control Unit 106]

### (2-2-4-1. Image Generation)

The output control unit 106 generates a right eye image and a left eye image on the basis of an image signal of content acquired by the content acquisition unit 102. For example, in the case where the content is 2D content, the output control unit 106 generates a right eye image and a left eye image on the basis of an (single) image signal of the content. Alternatively, in the case where the content is 3D content, the output control unit 106 generates a right eye image on the basis of a right eye image signal included in the content, and generates a left eye image on the basis of a left eye image signal included in the content.

More specifically, the output control unit 106 generates the right eye image by cutting out a region corresponding to the right eye image (that is a generation subject) from an image signal of the content, and generates the left eye image by cutting out a region corresponding to the left eye image (that is a generation subject) from an image signal of the content.

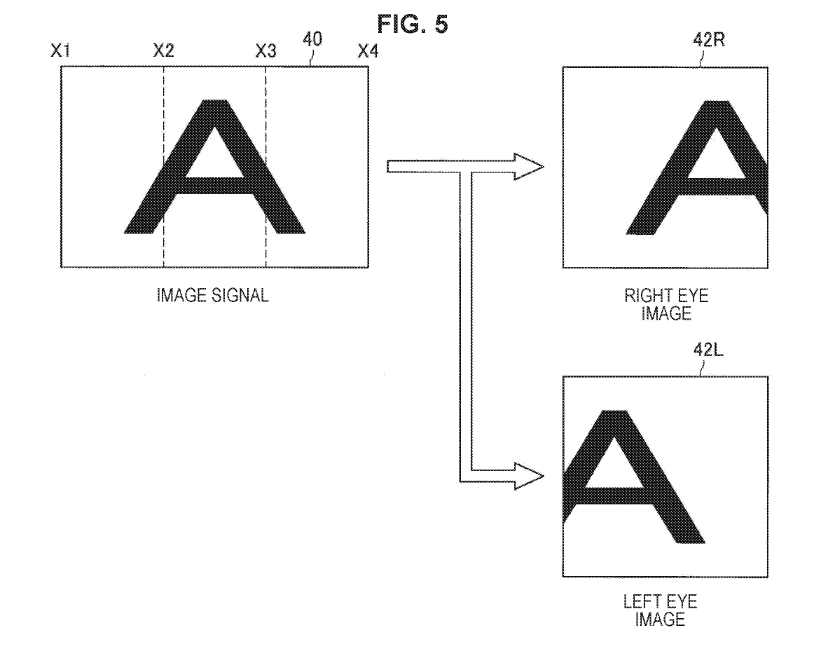

Next, with reference to FIG. 5 to FIG. 8, details of the above will be described. FIG. 5 is an explanatory diagram illustrating an example of generating a right eye image 42R and a left eye image 42L on the basis of an image signal 40 of 2D content. Note that, FIG. 5 illustrates an example of generating the right eye image 42R and the left eye image 42R such that the right eye image 42R and the left eye image 42L include a region of a section between x2 and x3 in a horizontal direction (x direction) of the image signal 40. For example, as illustrated in FIG. 5, the output control unit 106 generates the right eye image 42R by cutting out a region including a left end of the image signal 40 (specifically, a region of a section between x1 and x3) from the image signal 40. In addition, the output control unit 106 generates the left eye image 42L by cutting out a region including a right end of the image signal 40 (specifically, a region of a section between x2 and x4) from the image signal 40. Note that, each size of the right eye image 42R and the left eye image 42L falls within a range of a size that the left eye display unit 126L or the right eye display unit 126R can display, for example.

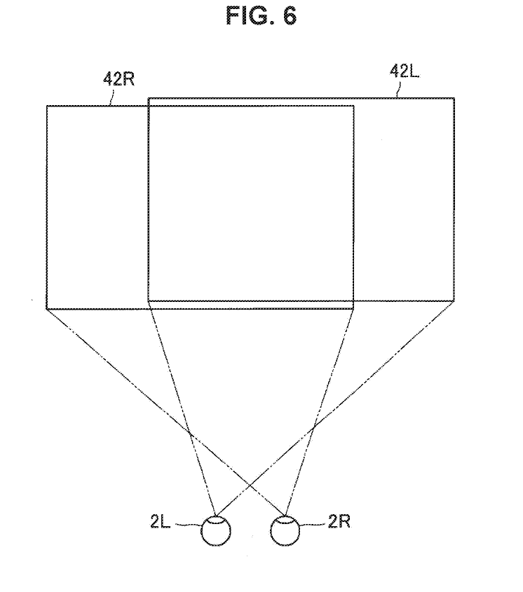

FIG. 6 is an explanatory diagram illustrating a relation between the left eye image 42L and the right eye image 42R obtained through the above-described generation example. As illustrated in FIG. 6, the left eye image 42L is observed by the left eye 2L, and the right eye image 42R is observed by the right eye 2R. In addition, as illustrated in FIG. 6, the left eye image 42L and the right eye image 42R are generated such that they include an overlap region and non-overlap regions. This enables to secure both a wide field of view and a wide binocular vision region.

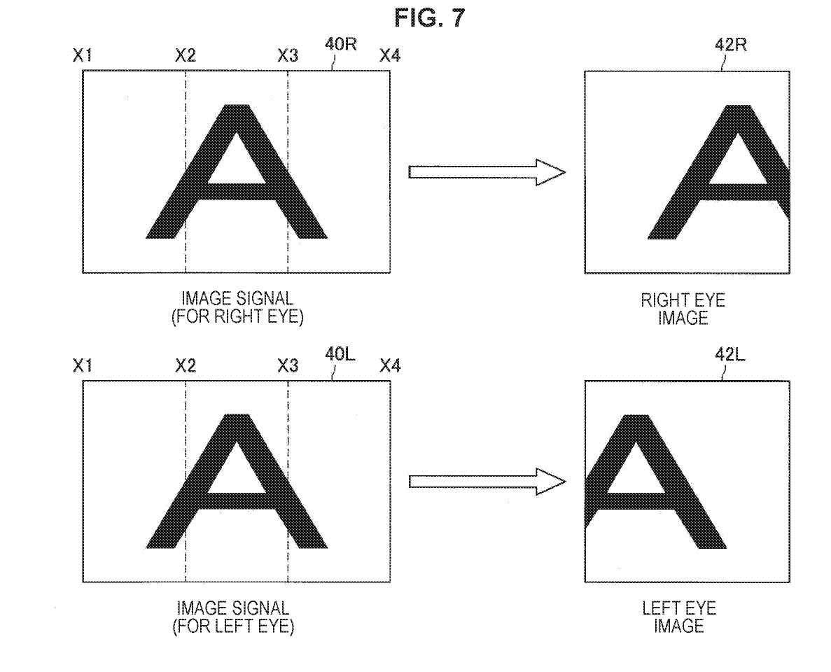

FIG. 7 is an explanatory diagram illustrating an example of generating a right eye image 42R and a left eye image 42L on the basis of 3D content. Note that, FIG. 7 illustrates an example of generating the right eye image 42R and the left eye image 42L such that the right eye image 42R and the left eye image 42L respectively includes a region of a section between x2 and x3 in a horizontal direction of a right eye image signal 40R of content, and a region of a section between x2 and x3 in a horizontal direction of a left eye image signal 40L of the content. For example, as illustrated in FIG. 7, the output control unit 106 generates the right eye image 42R by cutting out a region including a left end of the right eye image signal 40R (specifically, a region of a section between x1 and x3) as it is. In addition, the output control unit 106 generates the left eye image 42L by cutting out a region including a right end of the left eye image signal 40L (specifically, a region of a section between x2 and x4) as it is.

Note that, with reference to FIG. 5 and FIG. 7, the examples in which the right eye image and the left eye image are generated from the entire image signals of the content have been described. However, the present technology is not limited thereto. For example, it is also possible for the output control unit 106 to generate a right eye image or a left eye image on the basis of a region corresponding to a part of an image signal of content (such as a region of 80%).

### —Four Types of Streams

Note that, a plurality of streams may be prepared in advance for one piece of content. For example, four types of streams prepared for one piece of content include a left eye image signal and a right eye image signal of content that the display device such as a publicly-known see-through head-mounted display can display (hereinafter, also referred to as content for a reverse-V-shape display) and a left eye image signal and a right eye image signal of content that the HMD 10-1 can display (hereinafter, also referred to as content for the HMD 10-1). In this case, for example, the output control unit 106 generates a left eye image on the basis of the left eye image signal of the content for the HMD 10-1, and generates a right eye image on the basis of the right eye image signal of the content, among the four types of streams acquired by the content acquisition unit 102.

Note that, for example, it is also assumed that the left eye image signal or the right eye image signal of the content for the HMD 10-1 is not acquired because the left eye image signal or the right eye image signal of the content for the HMD 10-1 is not prepared in advance. In this case, for example, it is also possible for the output control unit 106 to generate an alternative image of the content for the HMD 10-1 on the basis of an existing image processing technology and a left eye image signal and a right eye image signal of content for a reverse-V-shape display acquired by the content acquisition unit 102. Subsequently, the output control unit 106 is capable of generating a left eye image and a right eye image on the basis of the generated alternative image.

### —Image Generation Using Content Information

Alternatively, it is also possible for the output control unit 106 to generate a right eye image and a left eye image on the basis of content information acquired by the content acquisition unit 102 (in addition to content). For example, it is possible for the output control unit 106 to generate a right eye image and a left eye image by cutting out a region corresponding to the right eye image (that is a generation subject) and a region corresponding to the left eye image (that is a generation subject) from the image signal of the content at a cutout position indicated by the content information. Alternatively, it is also possible for the output control unit 106 to generate a right eye image and a left eye image by enlarging or reducing a specific region or an entire image signal of content on the basis of the content information.

### —Image Generation Based on Image Analysis

Alternatively, the output control unit 106 is also capable of generating a right eye image and a left eye image on the basis of analysis of an image of acquired content. For example, it is possible for the output control unit 106 to generate a right eye image and a left eye image by determining a cutout position in accordance with an image analysis result of the content and cutting out a region corresponding to the right eye image and a region corresponding to the left eye image from the image signal of the content at the determined cutout position.

### —Clipping of Image Signal

Alternatively, the output control unit 106 is capable of clipping an image signal of content or enlarging/reducing the image signal of the content in accordance with an aspect ratio of an image that the left eye display unit 126L or the right eye display unit 126R can display. For example, in the case where acquired content is an image signal of “16:9 (=1920×1080)” and the left eye display unit 126L and the right eye display unit 126R are capable of displaying an image of “4:3 (=640×480)”, the output control unit 106 may reduce the acquired content to an image signal of “4:3” and generate a right eye image and a left eye image on the basis of the image with the reduced aspect ratio.

### —Determination of Display Region

Alternatively, the output control unit 106 is also capable of correcting a display position of content on the basis of the acquired content or content information. For example, the output control unit 106 determines whether to arrange (information included in) the content in a binocular vision region or in a monocular vision region (in other words, a region in which the right eye image and the left eye image do not overlap each other) on the basis of the acquired content or content information. For example, in the case where the acquired content is 3D content, the output control unit 106 arranges the content in the binocular vision region. Alternatively, in the case where the acquired content is 2D content, it is possible for the output control unit 106 to arrange the content in the monocular vision region.

Alternatively, the output control unit 106 determines an arrangement position of an object on the basis of a distance between a user and an initial position of the object included in content. For example, in the case where the distance between the user and the initial position of the object is smaller than a predetermined threshold, the output control unit 106 arranges the object in the binocular vision region. Alternatively, in the case where the distance between the user and the initial position of the object is larger than the predetermined threshold, the output control unit 106 arranges the object in the monocular vision region. Alternatively, in the case where the distance between the user and the initial position of the object is moderate and all or a part of the object is displayed in the monocular vision region, the output control unit 106 may display the object in the monocular vision region in a translucent manner, may display a defocused object, or may display a wire frame of the object. This enables causing the user to perceive the distance to the object ambiguously.

Alternatively, the output control unit 106 determines an arrangement position of an object included in content in accordance with a detected moving speed of a user. For example, in the case where the moving speed of the user is faster than a predetermined threshold, the output control unit 106 arranges the object in the monocular vision region (which is far away from the user). Alternatively, in the case where the moving speed of the user is slower than the predetermined threshold, the output control unit 106 arranges the object in the binocular vision region.

In addition, in the case of an image (expression) changing from 3D to 2D, the output control unit 106 may display the image in a simple manner. For example, the output control unit 106 may display such an image by crossfading a 3D image (generated in real time by a graphics processing unit (GPU), for example) and a 2D image that has been generated in advance. In addition, (while crossfading the image), the output control unit 106 may display a wire frame of an image to be displayed in a peripheral vision region in the image, may gradually reduce resolution, or may obscure the image through blurring or shading, for example.

In general, a human cognitive ability is very lower in the peripheral vision region than in a central vision region. According to the above-described control methods, boundary portions are displayed smoothly, for example. Therefore, the user does not perceive the image unnaturally. In addition, this also enables to reduce processing load of the GPU or the like, for example.

### (2-2-4-2. Image Correction Process)

Note that, in the case where the right eye image and the left eye image are generated by simply cutting out image signals of the content (especially, 3D content), the boundary potion may be perceived unnaturally between the monocular vision region and the binocular vision region. For example, border lines may be perceived. Therefore, the output control unit 106 preferably performs a correction process of suppressing change in luminance in the boundary portions between the monocular vision regions and in the binocular vision region, with regard to a cutout region of the right eye image and a cutout region of the left eye image.

For example, the output control unit 106 is capable of changing luminance of pixels by an amount of change corresponding to luminance of pixels in the cutout region of the right eye image or the cutout region of the left eye image in the content. For example, the output control unit 106 changes the luminance of the pixels on the basis of a predetermined gamma curve and the luminance of the pixels in the cutout region of the right eye image or the cutout region of the left eye image.

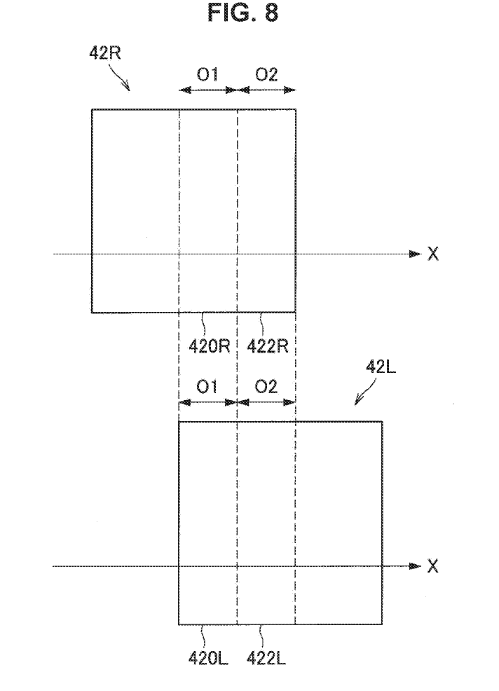

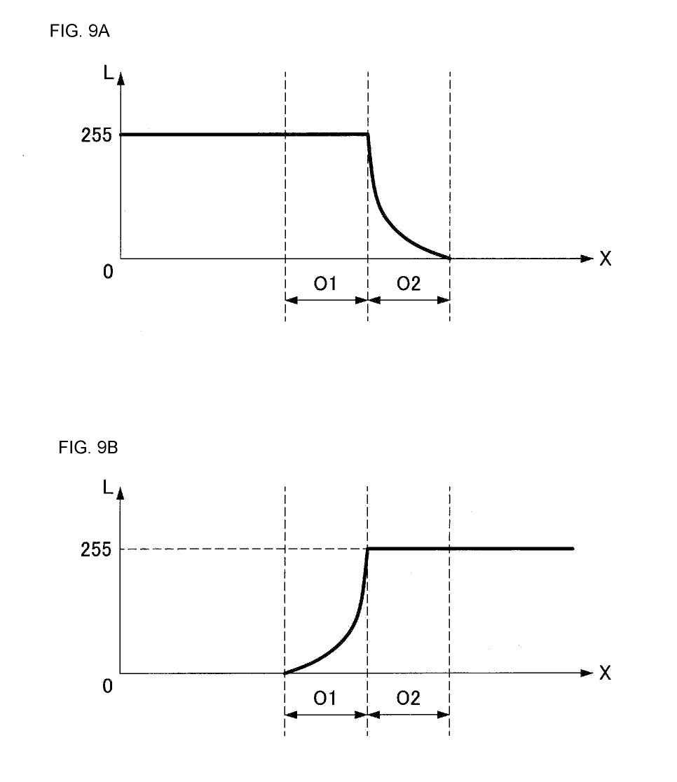

Next, with reference to FIG. 8 to FIG. 9, details of the above will be described. FIG. 8 is an explanatory diagram illustrating an example of a cutout region 42R of a right eye image and a cutout region 42L of a left eye image. Note that, to simplify the description, FIG. 8 illustrates a case where the colors of the entire cutout region 42R and the entire cutout region 42L are while (white screens). In addition, as illustrated in FIG. 8, portions of the cutout region 42R and the cutout region 42L overlap each other in sections “O1” and “O2” in an x direction. In addition, FIG. 9 is graphs illustrating examples of functions of correction to be performed on the cutout region 42R and the cutout region 42L illustrated in FIG. 8. Note that, FIG. 9 (a) is a graph illustrating an example of a function of correction to be performed on the cutout region 42R, and FIG. 9 (b) is a graph illustrating an example of a function of correction to be performed on the cutout region 42L.

For example, the output control unit 106 corrects luminance in an overlap region 422R in the section “O2” in the cutout region 42R (in other words, an overlap region including a right end of the cutout region 42R), by using a gamma curve having a shape illustrated in the section “O2” in FIG. 9(a). On the other hand, the output control unit 106 corrects luminance in an overlap region 420L in the section “O1” in the cutout region 42L of the left eye image (in other words, an overlap region including a left end of the cutout region 42L), by using a gamma curve having a shape illustrated in the section “O1” in FIG. 9(b). Note that, the shapes of the gamma curves are decided in accordance with luminance of pixels of the image signal of the content (“255 (maximum value)” is set for the both examples illustrated in FIG. 9). In addition, FIG. 9 illustrates the examples in which the minimum values of the luminance in the gamma curves are “0”. However, the present disclosure is not limited thereto, and any values can be used.

According to the above-described correction examples, it is possible to appropriately blend the cutout region of the right eye image and the cutout region of the left eye image at the boundary portion between the monocular vision region and the binocular vision region. This enables to moderate the change in luminance. Accordingly, it is possible for the user to naturally perceive the boundary portion.

In addition, the output control unit 106 is also capable of eliminating distortion of the right eye image and the left eye image that have been cut out.

### (2-2-4-3. Output of Image)

In addition, the output control unit 106 causes the right eye display unit 126R to display the generated right eye image, and causes the left eye display unit 126L to display the generated left eye image.

### [2-2-5. Communication Unit 120]

The communication unit 120 exchanges information with another device capable of communicating with the HMD 10-1. For example, the communication unit 120 transmits a predetermined content acquisition request to the server 20 under the control of the content acquisition unit 102. In addition, the communication unit 120 receives the content from the server 20.

### [2-2-6. Sensor Unit 122]

For example, the sensor unit 122 includes a triaxial acceleration sensor, a gyro scope, a magnetic sensor, an illuminance sensor, an image sensor, an infrared sensor, or the like. For example, the sensor unit 122 measures a speed, acceleration, inclination, a cardinal direction, or the like of the HMD 10-1. In addition, the sensor unit 122 measures brightness in an environment. In addition, the sensor unit 122 is also capable of detecting an external image and recording it as a digital image by using the image sensor or the infrared sensor.

In addition, the sensor unit 122 may include a positioning device configured to measure a current position by receiving a positioning signal from a positioning satellite such as the Global Positioning System (GPS), for example.

### [2-2-7. Storage Unit 124]

The storage unit 124 stores various kinds of data and various kinds of software.

### [2-2-8. Left Eye Display Unit 126L and Right Eye Display Unit 126R]

The left eye display unit 126L and the right eye display unit 126R display an image by emitting light. For example, the left eye display unit 126L and the right eye display unit 126R include image projection devices. In addition, the left eye display unit 126L and the right eye display unit 126R causes the image projection devices to project an image on at least respective partial regions of the left eye lens (left eye optical system) and the right eye lens (right eye optical system) that are serving as projection surfaces. Note that, the left-eye lens and the right-eye lens may include transparent material such as resin or glass, for example.

Note that, in a modification, each of the left eye display unit 126L and the right eye display unit 126R may include a liquid crystal panel, and may be capable of controlling transmittance of the liquid crystal panel. Accordingly, the left eye display unit 126L and the right eye display unit 126R may be controlled to be the transparent or translucent state.

In addition, as another modification, the left eye display unit 126L and the right eye display unit 126R may be configured as a non-see-through display device, and may successively display images of a gaze direction of a user captured by the sensor unit 122. For example, the left eye display unit 126L and the right eye display unit 126R may include a liquid crystal display (LCD), an organic light emitting diode (OLED), or the like.

### <2-3. Operation>

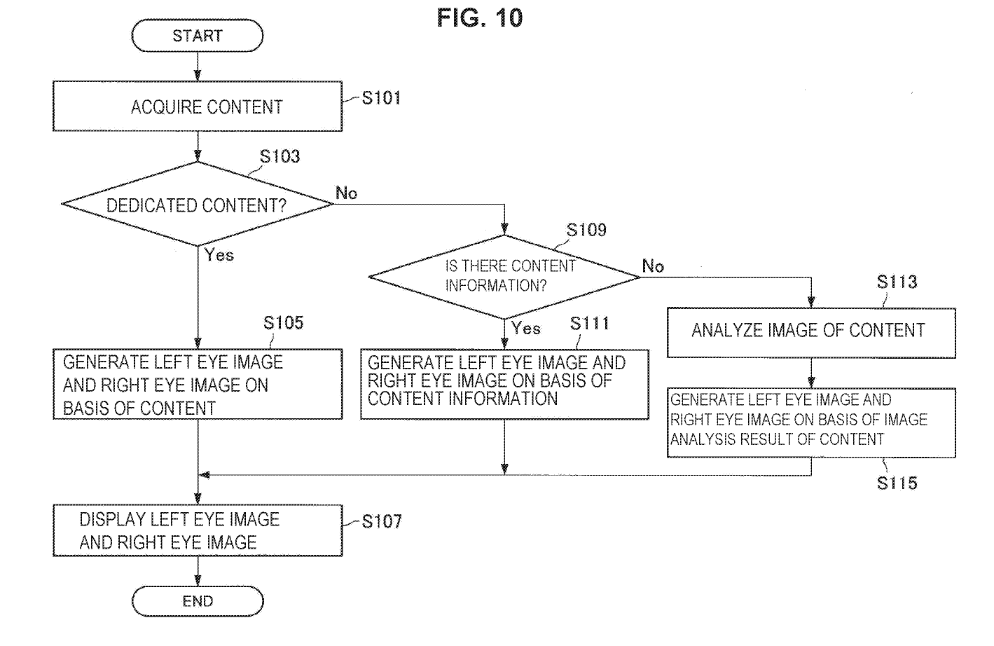

The configurations according to the first embodiment have been described above. Next, with reference to FIG. 10, an operation example according to the first embodiment will be described. FIG. 10 is a flowchart illustrating an operation example according to the first embodiment.

As illustrated in FIG. 10, the content acquisition unit 102 of the HMD 10-1 first acquires display subject content from the server 20, for example. In addition, in the case where content information is included in the content, the content acquisition unit 102 also acquires the content information (S101).

Next, the output control unit 106 determines whether the acquired content is dedicated content (in other words, content dedicated to the HMD 10-1) or not (S103).

In the case where the acquired content is the dedicated content (Yes in S103), the output control unit 106 generates a left eye image on the basis of a left eye image signal of the acquired content, and generates a right eye image on the basis of a right eye image signal of the content (S105).

Next, the left eye display unit 126L displays the generated left eye image under the control of the output control unit 106. In addition, the right eye display unit 126R displays the generated right eye image under the control of the output control unit 106 (S107).

Alternatively, in the case where the acquired content is not the dedicated content in S103 (No in S103) and content information of the content is acquired in S101 (Yes in S109), the output control unit 106 generates a right eye image and a left eye image on the basis of the acquired content and content information (S111). Next, the HMD 10-1 performs a process in S107.

Alternatively, in the case where the acquired content is not the dedicated content in S103 (No in S103) and content information of the content is not acquired in S101 (No in S109), the output control unit 106 first analyzes the image signal of the content (S113). Next, the output control unit 106 generates a right eye image and a left eye image on the basis of the content and an image analysis result (S115). Next, the HMD 10-1 performs a process in S107.

### <2-4. Effects>

As described above, in the HMD 10-1 according to the first embodiment, the right eye display unit 126R and the left eye display unit 126L are tilted in a manner that the plane passing through the right eye 2R and the center line intersects with the plane passing through the left eye 2L and the other center line, the center line being perpendicular to the right eye virtual image 30R, the other center line being perpendicular to the left eye virtual image 30L. This enables to secure both a wide field of view and a wide binocular vision region at the same time.

For example, in comparison with the publicly-known see-through head-mounted display, the device according to the present disclosure is capable of securing a binocular vision region staring from a position closer to a user. Therefore, in comparison with the publicly-known technology, the device according to the present disclosure is capable of appropriately displaying an image using binocular disparity view in a wider range in a region in which binocular disparity is more effective than the other cognition (in other words, a region close to a user). In addition, it is possible to cause a user to visually recognize an image with a wide field of view in a region in which motion parallax and relative sizes of objects are effective in object recognition (in other words, a region far from a user).

### <2-5. Modification>

Note that, the first embodiment is not limited to the above described examples. The example in which the content acquisition unit 102 and the output control unit 106 are included in the HMD 10-1 has been described above, for example. However, the present disclosure is not limited thereto. For example, instead of the HMD 10-1, the server 20 may include (at least a part of the respective functions of) the content acquisition unit 102 and the output control unit 106.

In addition, according to the modification, the server 20 is capable of generating a right eye image and a left eye image on the basis of display subject content and device information received from another device such as the HMD 10-1 or the like, and transmitting the generated right eye image and left eye image to the other device, for example. For example, the server 20 first determines whether a display of the other device is a reverse-V-shape display or a display for HMD 10-1 (in other words, a V-shape display) on the basis of the device information received from the other device. Next, the server 20 acquires two types of streams for the determined display (in other words, a left eye image signal and a right eye image signal for the determined display) among four types of streams of the display subject content, and generates a right eye image and a left eye image on the basis of the acquired streams. Next, the server 20 transmits the generated right eye image and left eye image to the other device.

### 3. Second Embodiment

The first embodiment has been described above. In the first embodiment, the example in which the positional relation (such as an angle) between the left eye display unit 126L and the right eye display unit 126R is fixed has been described.

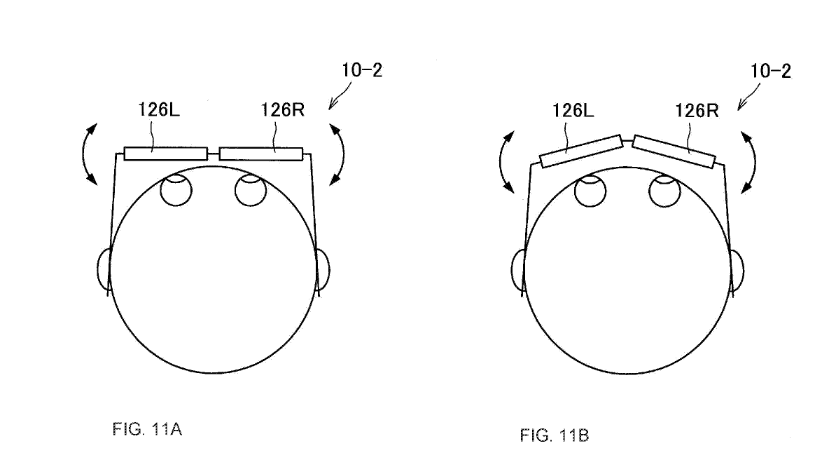

Meanwhile, a desirable positional relation between the left eye display unit 126L and the right eye display unit 126R may change in accordance with usage situations. For example, in the case of prioritizing a wide binocular vision region, it is desirable to determine a positional relation between the left eye display unit 126L and the right eye display unit 126R such that a wide overlap region between an image displayed on the left eye display unit 126L and an image displayed on the right eye display unit 126R is obtained. In this case, for example, as illustrated in FIG. 11(a), an angle between the left eye display unit 126L and the right eye display unit 126R is small. Alternatively, as illustrated in FIG. 2, it is desirable to incline the left eye display unit 126L and the right eye display unit 126R such that they form a V-shape.

In addition, in the case of prioritizing a wide field of view, it is desirable to determine a positional relation between the left eye display unit 126L and the right eye display unit 126R such that a small overlap region between an image displayed on the left eye display unit 126L and an image displayed on the right eye display unit 126R is obtained. In this case, for example, as illustrated in FIG. 11(b), it is desirable to incline the left eye display unit 126L and the right eye display unit 126R such that they form a reverse-V-shape, and obtain a large angle between the left eye display unit 126L and the right eye display unit 126R.

Next, the second embodiment will be described. As described below, it is possible for the HMD 10-2 according to the second embodiment to change a positional relation between the left eye display unit 126L and the right eye display unit 126R in accordance with usage situations.

Here, the positional relation between the left eye display unit 126L and the right eye display unit 126R may be changed manually or automatically. For example, it is possible to manually change the positional relation between the left eye display unit 126L and the right eye display unit 126R in response to operation performed on an operation unit (not illustrated) such as a dial attached to the HMD 10-2. Note that, the positional relation between the left eye display unit 126L and the right eye display unit 126R may include a plurality of stages in advance.

### <3-1. Configuration>

First, a configuration of the HMD 10-1 according to the second embodiment will be described. Note that, hereinbelow, description similar to the first embodiment will be omitted.

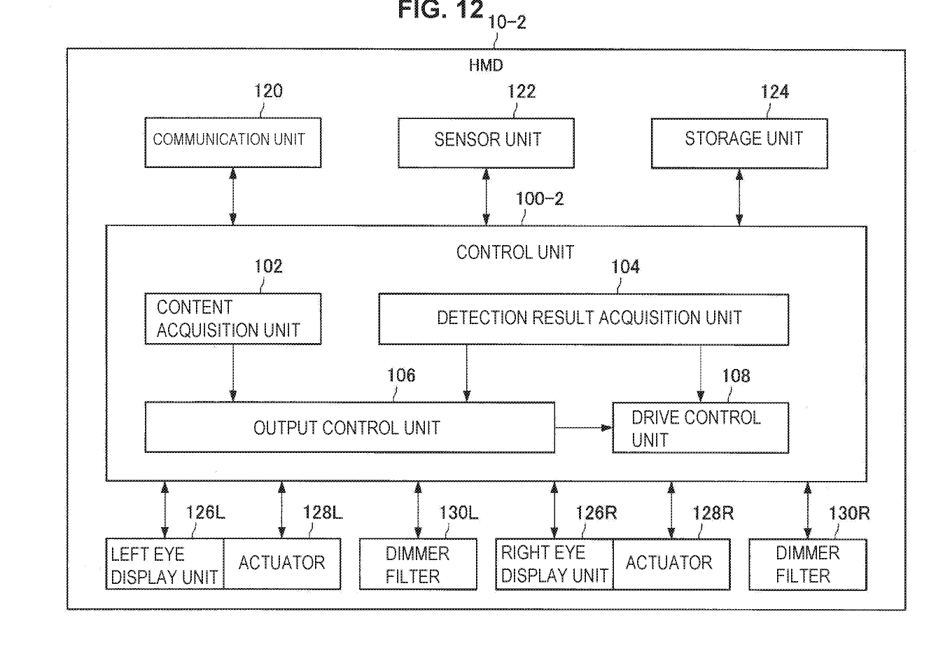

FIG. 12 is a functional block diagram illustrating the configuration of the HMD 10-2. As illustrated in FIG. 12, the HMD 10-2 includes the control unit 100-2 instead of the control unit 100-1 in comparison with the HMD illustrated in FIG. 4. The control unit 100-2 further includes a drive control unit 108. In addition, the HMD 10-2 further includes an actuator 128L, an actuator 128R, a dimmer filter 130L and a dimmer filter 130R.

### [3-1-1. Output Control Unit 106]

### (3-1-1-1. Determination of Display Region)

### —Information Related to Content

The output control unit 106 according to the second embodiment changes a region in content to be displayed on the left eye display unit 126L (hereinafter, referred to as a left eye display region) and a region in content to be displayed on the right eye display unit 126R (hereinafter, referred to as a right eye display region), on the basis of information related to display subject content. For example, the output control unit 106 changes a degree of overlap between the left eye display region and the right eye display region in accordance with information related to display subject content.

For example, in the case where the content is an image signal of “16:9”, the output control unit 106 shrinks an overlap region between the left eye display region and the right eye display region such that it becomes possible to display the image of “16:9”. In addition, in the case where the content includes setting data regarding the overlap between the regions, the output control unit 106 determines the left eye display region and the right eye display region in accordance with the setting data. In addition, in the case where the content is 2D content, the output control unit 106 may determine the left eye display region and the right eye display region such that the overlap region between the left eye display region and the right eye display region becomes smaller than a predetermined threshold (in other words, such that a total region including the left eye display region and the right eye display region becomes larger). Alternatively, in the case where the content is 3D content, the output control unit 106 may determine the left eye display region and the right eye display region such that the overlap region between the left eye display region and the right eye display region becomes larger than the predetermined threshold. In addition, in the case where the content is still image content, the output control unit 106 may determine the left eye display region and the right eye display region such that the overlap region between the left eye display region and the right eye display region becomes larger than a predetermined threshold.

In addition, the output control unit 106 is capable of determining the left eye display region and the right eye display region on the basis of a genre of the content. Here, the genre of the content includes supportive applications such as navigation, shopping, game, education, and a manual for assembling a plastic model, for example. For example, in the case where the genre indicates the navigation, the output control unit 106 may determine the left eye display region and the right eye display region such that the overlap region between the left eye display region and the right eye display region becomes larger than a predetermined threshold.

In addition, the output control unit 106 is also capable of determining the left eye display region and the right eye display region on the basis of information regarding chapters or scenes included in the content, for each chapter or scene.

Alternatively, in the case where a display subject (not content) is an application, the output control unit 106 may determine the left eye display region and the right eye display region such that the overlap region between the left eye display region and the right eye display region in the application becomes larger than a predetermined threshold, on the basis of information notified by the application.

Note that, in the case where the overlap between regions is not particularly prescribed in the application, or in the case where the overlap between regions is prescribed such that the overlap is variable in accordance with behavior of a user, the output control unit 106 is capable of determining the left eye display region and the right eye display region on the basis of a situation of a user or an environment.

### —Information Related to User or Environment

In addition, the output control unit 106 is capable of determining the left eye display region and the right eye display region on the basis of information regarding a user or an environment. Here, the information regarding a user or an environment may include age of the user, user setting information, a moving speed of the user, a result of recognizing behavior of the user, positional information of the user, and the like, for example.

### ——Age

For example, in the case where a user is not old enough to see 3D content (this is defined by a public agency, for example), the output control unit 106 may determine the left eye display region and the right eye display region such that the overlap region between the left eye display region and the right eye display region becomes smaller than a predetermined threshold, or such that there is no overlap region between the left eye display region and the right eye display region. Alternatively, in the case where a user is old enough to see 3D content, the output control unit 106 may determine the left eye display region and the right eye display region such that the overlap region between the left eye display region and the right eye display region becomes larger than the predetermined threshold.

### ——Setting Information

In addition, the output control unit 106 may determine the left eye display region and the right eye display region in accordance with whether or not wide-angle display is set by a user. For example, in the case where the wide-angle display is set, the output control unit 106 may determine the left eye display region and the right eye display region such that the overlap region between the left eye display region and the right eye display region becomes smaller than a predetermined threshold. Alternatively, in the case where the wide-angle display is not set, the output control unit 106 may determine the left eye display region and the right eye display region such that the overlap region between the left eye display region and the right eye display region becomes larger than the predetermined threshold.

### ——Moving Speed

In addition, the output control unit 106 is capable of determining the left eye display region and the right eye display region on the basis of a detected moving speed of a user. For example, in the case where the detected moving speed is faster than a predetermined threshold, the output control unit 106 may determine the left eye display region and the right eye display region such that the overlap region between the left eye display region and the right eye display region becomes larger than a predetermined threshold. Alternatively, in the case where the detected moving speed is slower than the predetermined threshold, the output control unit 106 may determine the left eye display region and the right eye display region such that the overlap region between the left eye display region and the right eye display region becomes smaller than the predetermined threshold.

### ——Behavior Recognition

In addition, the output control unit 106 is capable of determining the left eye display region and the right eye display region on the basis of a result of recognizing behavior of a user through the detection result acquisition unit 104. Here, the behavior of the user includes walking, running, riding a bicycle, being on a train, riding a vehicle, walking up or down stairs, being on an elevator, being on an escalator, and the like, for example.

For example, in the case where it is recognized that the user is walking, the output control unit 106 may determine the left eye display region and the right eye display region such that the overlap region between the left eye display region and the right eye display region becomes larger than a predetermined threshold. Alternatively, in the case where it is recognized that the user is running or riding a bicycle, the output control unit 106 may determine the left eye display region and the right eye display region such that the overlap region between the left eye display region and the right eye display region becomes smaller than the predetermined threshold.

In addition, in the case where it is recognized that the user is being on a train or riding a vehicle, the output control unit 106 may determine the left eye display region and the right eye display region in accordance with a detected moving speed of the train or the vehicle. For example, in the case where the detected moving speed of the train or the vehicle is faster than a predetermined speed, the output control unit 106 may determine the left eye display region and the right eye display region such that the overlap region between the left eye display region and the right eye display region becomes smaller than a predetermined threshold. Alternatively, in the case where the detected moving speed of the train or the vehicle is slower than the predetermined speed, the output control unit 106 may determine the left eye display region and the right eye display region such that the overlap region between the left eye display region and the right eye display region becomes larger than the predetermined threshold.

In addition, in the case where it is recognized that the user is walking up or down stairs, the output control unit 106 may determine the left eye display region and the right eye display region such that the overlap region between the left eye display region and the right eye display region becomes smaller than a predetermined threshold.

### ——Position or Place

In addition, the output control unit 106 is also capable of determining the left eye display region and the right eye display region on the basis of information regarding a detected position of a user. For example, the output control unit 106 may acquire information including designation of overlap between regions from a server 20 for example, and determine the left eye display region and the right eye display region on the basis of the acquired information. The information including designation of overlap between regions is associated with detected positional information of the user.

In addition, the output control unit 106 is also capable of determining the left eye display region and the right eye display region in accordance with a place where the user is present. The place is detected by the detection result acquisition unit 104. For example, in the case where it is detected that the user is in an amusement park, the output control unit 106 may acquire information including designation of overlap between regions, and determine the left eye display region and the right eye display region on the basis of the acquired information. The information including designation of an overlap region is issued from an organizer of the amusement park. Alternatively, in the case where it is detected that the user is in a store such as a department store, the output control unit 106 may acquire information including designation of overlap between regions, and determine the left eye display region and the right eye display region on the basis of the acquired information. The information including designation of an overlap region is issued from an organizer of the department store.

In addition, the output control unit 106 may determine the left eye display region and the right eye display region on the basis of a result of detecting whether a user is in a room or not.

### ——Behavior History

In addition, the output control unit 106 is also capable of determining the left eye display region and the right eye display region on the basis of whether or not a setting for referring to past user statuses is configured. For example, in the case where a setting for referring to past user statuses is configured, the output control unit 106 may determine the left eye display region and the right eye display region in accordance with a behavior history of the user. For example, the output control unit 106 determines the left eye display region and the right eye display region on the basis of a history of a setting regarding a degree of overlap between the left eye display region and the right eye display region at the time of displaying content that is similar to or the same as display subject content in the past. For example, the output control unit 106 determines an overlap region between the left eye display region and the right eye display region such that the over region becomes the same as a degree of overlap that has been set most frequently in the past.

Here, the behavior history may be a behavior history of a target user himself/herself, or may be a behavior history of another user related to the target user. For example, the other user may be all or a part of users registered in a predetermined service that the target user uses.

In addition, in the case where a setting for referring to past user statuses is not configured, the output control unit 106 may determine the left eye display region and the right eye display region in accordance with current setting information regarding overlap between regions.

### (3-1-1-2. Image Generation)

In addition, the output control unit 106 generates a left eye image on the basis of the determined left eye display region, and generates a right eye image on the basis of the determined right eye display region.

Note that, the output control unit 106 is also capable of determining whether to arrange an object in the binocular vision region or the monocular vision region in accordance with a current positional relation between the left eye display unit 126L and the right eye display unit 126R, and then generating a left eye image and a right eye image on the basis of the determined arrangement of the object. The object is included in the determined left eye display region or right eye display region.

### (3-1-1-3. Output of Guide Information)

In addition, in the case where it is possible to manually change a positional relation between the left eye display unit 126L and the right eye display unit 126R, the output control unit 106 controls output of guide information for instructing a user to change the positional relation in accordance with the determined left eye display region and right eye display region. Here, the guide information may include not only content of the change in positional relation (for example, turning the dial to the number “3”), but also an instruction regarding a timing to change the positional relation.

For example, the output control unit 106 may cause the left eye display unit 126L or the right eye display unit 126R to display a UI that instructs a user to change the positional relation in accordance with the determined left eye display region and right eye display region, or may blink an LED in accordance with a blinking pattern corresponding to the guide information. The LED is installed in the HMD 10-2. Alternatively, the output control unit 106 may output sound of the guide information, or may vibrate the HMD 10-2 or another device carried by the user.

(3-1-1-4. Display Indicating that Positional Relation is Changing)

Alternatively, in the case where it is possible to automatically change the positional relation between the left eye display unit 126L and the right eye display unit 126R (under the control of the drive control unit 108 to be described later), the output control unit 106 causes the left eye display unit 126L or the right eye display unit 126R to show a display indicating that the positional relation between the left eye display unit 126L and the right eye display unit 126R is changing. For example, the output control unit 106 may cause the left eye display unit 126L or the right eye display unit 126R to display text or an image indicating that the positional relation is changing. Alternatively, it is also possible for the output control unit 106 to temporarily darken an image that is currently being displayed on the left eye display unit 126L or the right eye display unit 126R, to mist all or a part of the displayed image, or to hide all or a part of the displayed image.

According to the above-described control examples, visibility is reduced when the positional relation between the left eye display unit 126L and the right eye display unit 126R is changed. Accordingly, it is possible to reduce a feeling of strangeness regarding viewing, or to reduce visually induced motion sickness.

### [3-1-2. Drive Control Unit 108]

The drive control unit 108 performs control such that a positional relation between the left eye display unit 126L and the right eye display unit 126R automatically changes, on the basis of the left eye display region and right eye display region that have been determined by the output control unit 106. For example, the drive control unit 108 drives the actuator 128L or the actuator 128R such that the positional relation between the left eye display unit 126L and the right eye display unit 126R becomes a positional relation corresponding to the determined left eye display region and right eye display region.

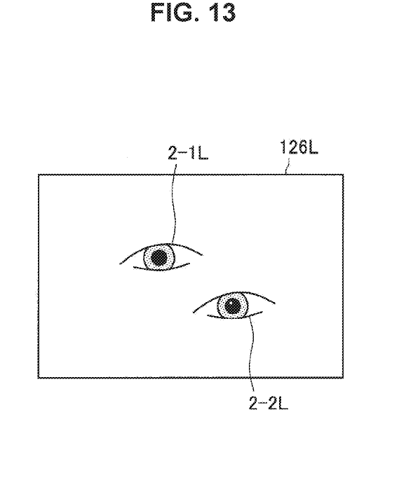

Meanwhile, when wearing the HMD 10-2, positions of eyes of a user with respect to the left eye display unit 126L or the right eye display unit 126R may vary depending on each user. For example, as illustrated in FIG. 13, a position 2-1L of a left eye of a certain user with respect to the left eye display unit 126L is drastically different from a position 2-2L of a left eye of another user. In addition, sometimes it is impossible for a user to visually recognize display subject content in a way that a content producer expects (it is impossible for a user to visually recognize appearance that the content producer expects) depending on positions of the eyes of the user with respect to the left eye display unit 126L or the right eye display unit 126R.

Therefore, it is preferable for the drive control unit 108 to perform control such that the positional relation between the left eye display unit 126L and the right eye display unit 126R changes on the basis of a result of detecting a position of the left eye with respect to the left eye display unit 126L or a position of the right eye with respect to the right eye display unit 126R, and a way to see a target that is determined in advance for each piece of content, for example.

### [3-1-3. Actuator 128L and Actuator 128R]

The actuator 128L and the actuator 128R changes angles or positions of the left eye display unit 126L or the right eye display unit 126R under the control of the drive control unit 108.

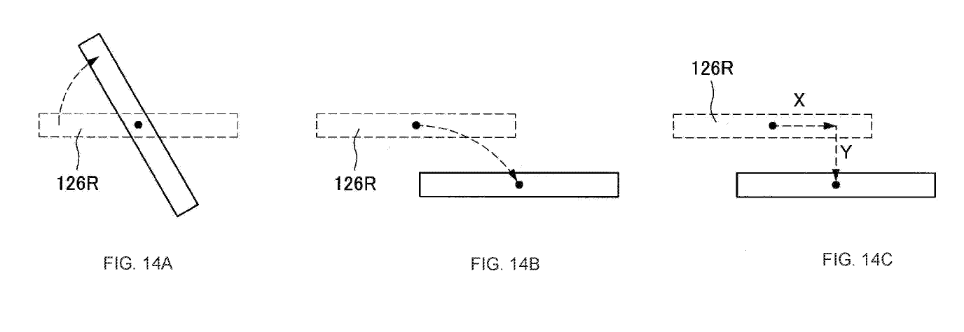

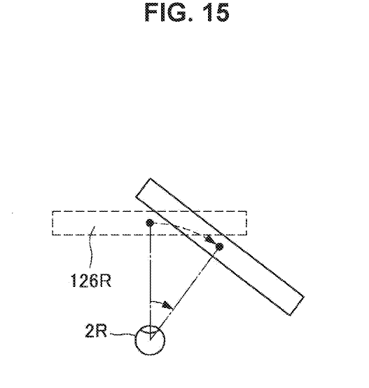

FIG. 14 and FIG. 15 are explanatory diagrams (top views) illustrating examples of transfer of the right eye display unit 126R performed by the actuator 128R. For example, as illustrated in FIG. 14(a), the actuator 128R is capable of rotating the right eye display unit 126R by ±90° for example, around a predetermined position of the right eye display unit 126R. In addition, as illustrated in FIG. 14(b), the actuator 128R is also capable of rotationally transferring the position of the right eye display unit 126R along a rail (not illustrated) or the like provided with the HMD 10-2 while maintaining the angle of the right eye display unit 126R, for example. In addition, as illustrated in FIG. 14(c), the actuator 128R is also capable of parallelly transferring the right eye display unit 126R along the rail or the like, for example.

Alternatively, for example, in the case where movement of a right eye 2R is detected as illustrated in FIG. 15, the drive control unit 108 is also capable of causing the actuator 128R to change a position or an angle of the right eye display unit 126R in accordance with the detected movement of the right eye 2R.

Note that, although FIG. 14 and FIG. 15 illustrate the transfer examples of the right eye display unit 126R, it is also possible to transfer the left eye display unit 126L in similar ways. In other words, the actuator 128L is capable of transferring the left eye display unit 126L in the similar ways.

### [3-1-4. Dimmer Filter 130L and Dimmer Filter 130R]

For example, each of the dimmer filter 130L and the dimmer filter 130R include a transmitting light amount variable device such as electrochromic. The dimmer filter 130L and the dimmer filter 130R reduce transmitting light amounts under the control of the control unit 100-2.

### [3-1-5. Modification]

Note that, the configuration of the HMD 10-2 according to the second embodiment is not limited to the above. For example, the positional relation between the left eye display unit 126L and the right eye display unit 126R may be changed manually only. In addition, in this case, the HMD 10-2 does not have to include the drive control unit 108, the actuator 128L, or the actuator 128R.

In addition, the HMD 10-2 does not have to include the dimmer filter 130L or the dimmer filter 130R.

### <3-2. Operation>

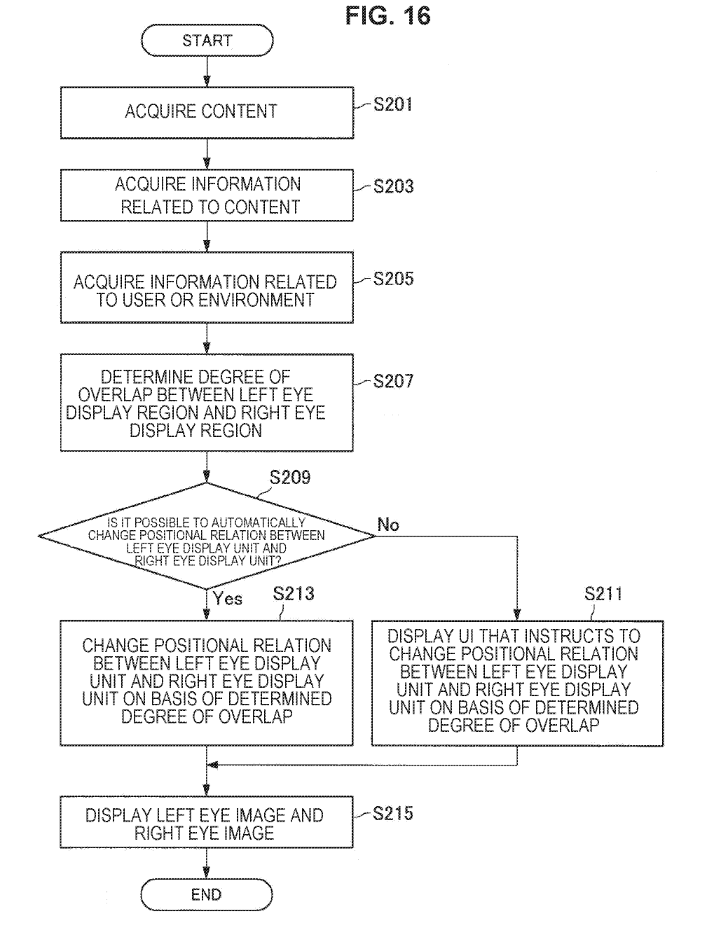

The configurations according to the second embodiment have been described above. Next, an operation example according to the second embodiment will be described. FIG. 16 is a flowchart illustrating an operation example according to the second embodiment. Note that, S201 illustrated in FIG. 16 is similar to S101 according to the first embodiment.

After S201, the content acquisition unit 102 of the HMD 10-2 acquires information related to content acquired in S201 from the server 20, for example (S203).

Next, the detection result acquisition unit 104 acquires information regarding a user or an environment (S205). The information regarding the user or the environment is detected by the sensor unit 122.

Next, the output control unit 106 determines a degree of overlap between the left eye display region and the right eye display region on the basis of the information related to the content acquired in S203, and the information regarding the user or the environment acquired in S205. Subsequently, the output control unit 106 generates a right eye image on the basis of the determined right eye display region, and generates a left eye image on the basis of the determined left eye display region (S207).

Next, in the case where it is impossible to automatically change the positional relation between the left eye display unit 126L and the right eye display unit 126R, in other words, in the case where it is possible to change the positional relation manually only (No in S209), the output control unit 106 causes the right eye display unit 126R or the left eye display unit 126L to display a UI that instructs the user to change the positional relation between the right eye display unit 126R and the left eye display unit 126L in accordance with a degree of overlap determined in S207. Subsequently, the user operates an operation unit of the HMD 10-2 in accordance with the displayed UI to change the positional relation between the right eye display unit 126R and the left eye display unit 126L, for example (S211). Next, the HMD 10-2 performs a process in S215 (to be described later).

On the other hand, in the case where it is possible to automatically change the positional relation between the left eye display unit 126L and the right eye display unit 126R (Yes in S209), the drive control unit 108 drives the actuator 128L or the actuator 128R such that the positional relation between the left eye display unit 126L and the right eye display unit 126R changes in accordance with a degree of overlap determined in S207 (S213).

Note that, S215 illustrated in FIG. 16 is similar to S107 according to the first embodiment.

### <3-3. Effects>

As described above, it is possible for the HMD 10-2 according to the second embodiment to change the degree of overlap between the left eye display region and the right eye display region in accordance with usage situations.

For example, in the case of prioritizing a wide binocular vision region, the HMD 10-2 determines the left eye display region and the right eye display region such that a wide overlap region between the left eye display region and the right eye display region is obtained. Alternatively, in the case of prioritizing a wide field of view, the HMD 10-2 determines the left eye display region and the right eye display region such that a small overlap region between the left eye display region and the right eye display region is obtained. As described above, the HMD 10-2 is capable of dynamically adjusting the size of the field of view and the size of the binocular vision region. Therefore, it is possible for the HMD 10-2 to display an optimum image that varies for each of the usage situations.

### <3-4. Modification>

Note that, the second embodiment is not limited to the above. For example, in the case where a part of the HMD 10-2 is malfunctioning, the output control unit 106 is capable of outputting display, sound, or vibration that indicates an error. For example, in such a case, the drive control unit 108 may drive the actuator 128L or the actuator 128R such that the angle of the left eye display unit 126L and the angle of the right eye display unit 126R become parallel to each other.

Alternatively, in the case where it becomes impossible to detect necessary information such as a moving speed during driving a vehicle, the output control unit 106 may shrink an overlap region between the left eye display region and the right eye display region, for example. According to such a modification, it is possible to improve safety during using the HMD 10-2.

### 4. Hardware Configuration

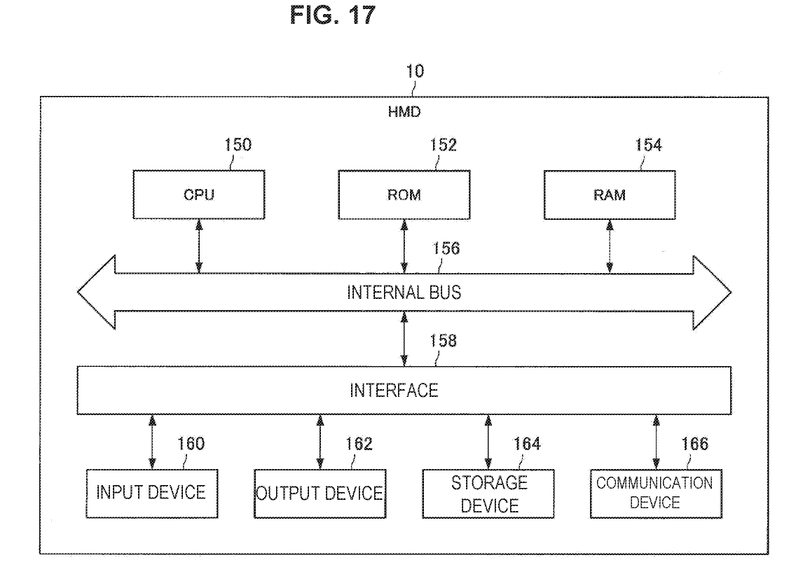

Next, with reference to FIG. 17, a hardware configuration of the HMD 10 that is common to the respective embodiments will be described. As illustrated in FIG. 17, the HMD 10 includes a CPU 150, ROM 152, RAM 154, an internal bus 156, an interface 158, an input device 160, an output device 162, a storage device 164, and a communication device 166.

The CPU 150 functions as an arithmetic device and a control device to control all of the operating processes in the HMD 10 in accordance with various kinds of programs. In addition, the CPU 150 realizes the function of the control unit 100-1 or the control unit 100-2. Note that, the CPU 150 is implemented by a processor such as a microprocessor.

The ROM 152 stores programs used by the CPU 150, control data such as operation parameters, and the like.

The RAM 154 temporarily stores programs and the like executed by the CPU 150, for example.

The internal bus 156 is implemented by a CPU bus or the like. The internal bus 156 mutually connects the CPU 150, the ROM 152, with the RAM 154.

The interface 158 connects the input device 160, the output device 162, the storage device 164, and the communication device 166 with the internal bus 156.

The storage device 164 is a data storage device that functions as the storage unit 124. For example, the storage device 164 may include a storage medium, a recording device configured to record data in the storage medium, a reader device configured to read data from the storage medium, a deletion device configured to delete data recorded in the storage medium, and the like.

The communication device 166 is a communication interface including a communication device or the like configured to connect with the communication network 22. In addition, the communication device 166 may be a wireless LAN compatible communication device, a long term evolution (LTE) compatible communication device, or may be a wired communication device that performs wired communication. The communication device 166 functions as the communication unit 120.

### 5. Modification

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

### <5-1. Modification 1>

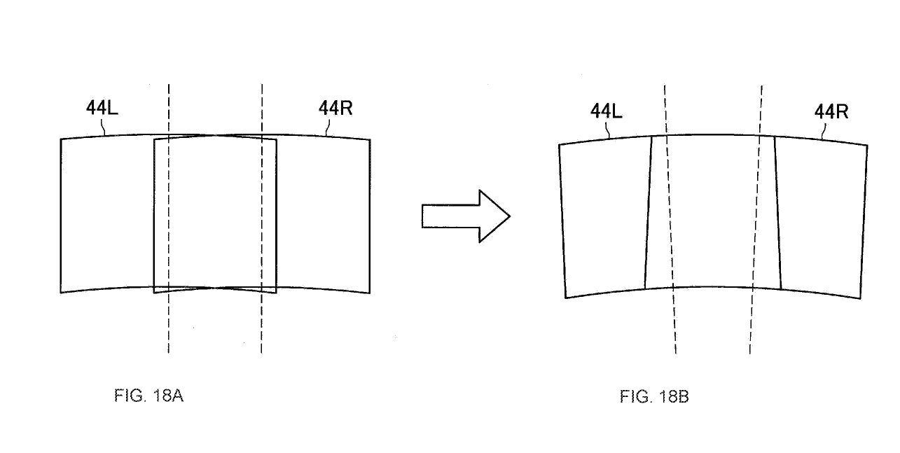

For example, in the case where the left eye display and the right eye display are distorted, visibility is reduced unfortunately. Next, with reference to FIG. 18(a), details of the above will be described. In the case where the left eye display and the right eye display are distorted, for example, joints between the left eye display region 44L and the right eye display region 44R become uneven as indicated by dashed lines in FIG. 18(a). Therefore the user may feel uncomfortable with regions around the joints.

Accordingly, it is desirable for the HMD 10 to change a positional relation between the left eye display and the right eye display (such as an angle between the displays) in accordance with distortions of the left eye display and the right eye display. This enables to smooth the joints in the overlap region between the left eye display region 44L and the right eye display region 44R as illustrated in FIG. 18(b). Therefore, it is possible to cause the user to naturally perceive it without the uncomfortable feeling.

### <5-2. Second Modification>

In addition, in the above described embodiments, the example in which the display device and the information processing device according to the present disclosure serve as HMDs 10 has been described. However, the present disclosure is not limited thereto. For example, the display device or the information processing device may be a projector device configured to draw an image on retina by using laser light, for example.

### <5-3. Third Modification>

In addition, all the structural elements included in the control unit 100-1 (or the control unit 100-2) may be installed in the server 20 instead of the HMD 10-1 (or the HMD 10-2). In addition, in this case, the display device or the information processing device according to the present disclosure may serve as the server 20 instead of the HMD 10-1 (or the HMD 10-2).

Alternatively, the display device or the information processing device may be another type of device capable of connecting with the communication network 22, such as a personal computer (PC), a smartphone, a tablet terminal, or a game console.

In addition, according to the above described embodiment, it is also possible to provide a computer program for causing hardware such as the CPU 150, ROM 152, and RAM 154, to execute functions equivalent to the structural elements of the HMD 10-1 or the HMD 10-2 according to the above described embodiments. Moreover, it is also possible to provide a recording medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

A display device including:

a right eye optical system configured to conduct image light to a right eye and form a right eye virtual image; and

a left eye optical system configured to conduct image light to a left eye and form a left eye virtual image,

in which a plane passing through the right eye and a first straight line intersects with a plane passing through the left eye and a second straight line, the first straight line being perpendicular to the right eye virtual image, the second straight line corresponding to the first straight line and being perpendicular to the left eye virtual image.
(2)

The display device according to (1), further including

an output control unit configured to cause the right eye optical system to display a right eye image corresponding to the right eye virtual image, and cause the left eye optical system to display a left eye image corresponding to the left eye virtual image.
(3)

The display device according to (2),

in which the output control unit causes the right eye image and the left eye image to be displayed such that a first region included in the right eye image and a second region included in the left eye image overlap each other.
(4)

The display device according to (3),

in which the right eye optical system and the left eye optical system are configured such that at least a part of an image corresponding to the first region included in the right eye virtual image and at least a part of an image corresponding to the second region included in the right eye virtual image overlap each other.
(5)

The display device according to (3) or (4),

in which the output control unit generates the right eye image and the left eye image on a basis of content that is a display subject.
(6)

The display device according to (5), in which

the content includes a first image signal and a second image signal corresponding to the first image signal,

the output control unit generates the right eye image by cutting out a region corresponding to the right eye image from the first image signal, and

the output control unit generates the left eye image by cutting out a region corresponding to the left eye image from the second image signal.
(7)

The display device according to (6),

in which a distance between an end of the first image signal in a horizontal direction and the region corresponding to the right eye image is smaller than a distance between the end of the second image signal in the horizontal direction and the region corresponding to the left eye image.
(8)

The display device according to (7), in which

a size of the first image signal is identical to a size of the second image signal, and

a size of the right eye image is identical to a size of the left eye image.
(9)

The display device according to any one of (6) to (8),

in which the first image signal and the second image signal include three-dimensional image.
(10)

The display device according to any one of (6) to (9), in which

a third region that is a region other than the first region in the right eye image is identical to a region corresponding to the third region in the first image signal, and

the first region is a region obtained by performing a predetermined correction process on a region corresponding to the first region in the first image signal.
(11)

The display device according to (10),

in which the predetermined correction process is a process of changing luminance of a pixel in accordance with the luminance of the pixel in the first image signal.
(12)

The display device according to (11),

in which the predetermined correction process is a process of changing luminance of another pixel adjacent to a pixel, by an amount of change corresponding to luminance of the pixel in the first image signal.
(13)

The display device according to (11) or (12),

in which the predetermined correction process is a process of changing luminance of a pixel on a basis of the luminance of the pixel in the first image signal and a predetermined gamma curve.
(14)

The display device according to any one of (6) to (13),

in which the second region is identical to a region corresponding to the second region in the second image signal.
(15)

The display device according to any one of (6) to (14),

in which the output control unit generates the right eye image and the left eye image further on a basis of information related to the content.
(16)

The display device according to (15),

in which the output control unit changes an arrangement position of information included in the content with respect to the right eye image or the left eye image on a basis of the information related to the content.
(17)

The display device according to any one of (5) to (16),

in which the output control unit generates the right eye image and the left eye image further on a basis of a size of the right eye optical system or the left eye optical system.
(18)

The display device according to any one of (5) to (17),

in which the output control unit generates the right eye image and the left eye image further on a basis of detection of information regarding a state of the display device.
(19)

The display device according to (18), in which

the information regarding the state of the display device includes a speed of the display device, and

the output control unit generates the right eye image and the left eye image on a basis of a detected speed of the display device.
(20)

The display device according to any one of (5) to (19),

in which the output control unit generates the right eye image and the left eye image further on a basis of detection of information regarding an environment around the display device.

### REFERENCE SIGNS LIST

10-1, 10-2 HMD
20 server
22 communication network
100-1, 100-2 control unit
102 content acquisition unit
104 detection result acquisition unit
106 output control unit
108 drive control unit
120 communication unit
122 sensor unit
124 storage unit
126L left eye display unit
126R right eye display unit
128L, 128R actuator
130L, 130R dimmer filter

1. A display device comprising:
a right eye optical system configured to conduct image light to a right eye and form a right eye virtual image; and
a left eye optical system configured to conduct image light to a left eye and form a left eye virtual image,
wherein a plane passing through the right eye and a first straight line intersects with a plane passing through the left eye and a second straight line, the first straight line being perpendicular to the right eye virtual image, the second straight line corresponding to the first straight line and being perpendicular to the left eye virtual image.

2. The display device according to claim 1, further comprising
an output control unit configured to cause the right eye optical system to display a right eye image corresponding to the right eye virtual image, and cause the left eye optical system to display a left eye image corresponding to the left eye virtual image.

3. The display device according to claim 2,
wherein the output control unit causes the right eye image and the left eye image to be displayed such that a first region included in the right eye image and a second region included in the left eye image overlap each other.

4. The display device according to claim 3,
wherein the right eye optical system and the left eye optical system are configured such that at least a part of an image corresponding to the first region included in the right eye virtual image and at least a part of an image corresponding to the second region included in the right eye virtual image overlap each other.

5. The display device according to claim 3,
wherein the output control unit generates the right eye image and the left eye image on a basis of content that is a display subject.

6. The display device according to claim 5, wherein
the content includes a first image signal and a second image signal corresponding to the first image signal,
the output control unit generates the right eye image by cutting out a region corresponding to the right eye image from the first image signal, and
the output control unit generates the left eye image by cutting out a region corresponding to the left eye image from the second image signal.

7. The display device according to claim 6,
wherein a distance between an end of the first image signal in a horizontal direction and the region corresponding to the right eye image is smaller than a distance between the end of the second image signal in the horizontal direction and the region corresponding to the left eye image.

8. The display device according to claim 7, wherein
a size of the first image signal is identical to a size of the second image signal, and
a size of the right eye image is identical to a size of the left eye image.

9. The display device according to claim 6,
wherein the first image signal and the second image signal include a three-dimensional image.

10. The display device according to claim 6, wherein
a third region that is a region other than the first region in the right eye image is identical to a region corresponding to the third region in the first image signal, and
the first region is a region obtained by performing a predetermined correction process on a region corresponding to the first region in the first image signal.

11. The display device according to claim 10,
wherein the predetermined correction process is a process of changing luminance of a pixel in accordance with the luminance of the pixel in the first image signal.

12. The display device according to claim 11,
wherein the predetermined correction process is a process of changing luminance of another pixel adjacent to a pixel, by an amount of change corresponding to luminance of the pixel in the first image signal.

13. The display device according to claim 11,
wherein the predetermined correction process is a process of changing luminance of a pixel on a basis of the luminance of the pixel in the first image signal and a predetermined gamma curve.

14. The display device according to claim 6,
wherein the second region is identical to a region corresponding to the second region in the second image signal.

15. The display device according to claim 6,
wherein the output control unit generates the right eye image and the left eye image further on a basis of information related to the content.

16. The display device according to claim 15,
wherein the output control unit changes an arrangement position of information included in the content with respect to the right eye image or the left eye image on a basis of the information related to the content.

17. The display device according to claim 5,
wherein the output control unit generates the right eye image and the left eye image further on a basis of a size of the right eye optical system or the left eye optical system.

18. The display device according to claim 5,
wherein the output control unit generates the right eye image and the left eye image further on a basis of detection of information regarding a state of the display device.

19. The display device according to claim 18, wherein
the information regarding the state of the display device includes a speed of the display device, and
the output control unit generates the right eye image and the left eye image on a basis of a detected speed of the display device.

20. The display device according to claim 5,
wherein the output control unit generates the right eye image and the left eye image further on a basis of detection of information regarding an environment around the display device.
